(19) United States
(12) Patent Application Publication
(10) Pub. No.: US 2026/0163013 A1
(43) Pub. Date: Jun. 11, 2026

(54) Electrode, method for manufacturing the same, and anode-less all-solid-state battery comprising the same

(71) Applicants: HYUNDAI MOTOR COMPANY, SEOUL (KR); KIA CORPORATION, SEOUL (KR); Seoul National University R&DB Foundation, Seoul (KR)

(72) Inventors: Ji Young Kim, Gyeonggi-do (KR); Ki Yoon Bae, Gyeonggi-do (KR); Jong Chan Song, Gyeonggi-do (KR); Sang Heon Lee, Gyeonggi-do (KR); Jang Wook Choi, Seoul (KR); Ji Hoon Oh, Seoul (KR); Noh Joon Lee, Seoul (KR); Ye Eun Sohn, Seoul (KR)

(73) Assignees: HYUNDAI MOTOR COMPANY, SEOUL (KR); KIA CORPORATION, SEOUL (KR); Seoul National University R&DB Foundation, Seoul (KR)

(21) Appl. No.: 19/318,926

(22) Filed: Sep. 4, 2025

(30) Foreign Application Priority Data
Dec. 10, 2024 (KR) 10-2024-0182970
Jun. 11, 2025 (KR) 10-2025-0076704

(51) Int. Cl. H01M 4/66; H01M 4/02; H01M 4/04; H01M 10/0562

(52) U.S. Cl. CPC H01M 4/667; H01M 4/0404; H01M 4/662; H01M 4/663; H01M 10/0562; H01M 2004/028; H01M 2300/0068

(57) ABSTRACT

An electrode, a method for manufacturing the same, and an anode-less all-solid-state battery comprising the electrode, where the electrode includes a current collector, and an intermediate layer disposed on the current collector, and the intermediate layer comprises a matrix comprising a carbon material, a lithium-alloyable metallic element, a lithium-alloyable metalloid element, or a combination thereof, which is dispersed in the matrix, and a lithium-alloyable metal oxide, a lithium-alloyable metal fluoride, a lithium-alloyable metalloid oxide, a lithium-alloyable metalloid fluoride, or a combination thereof, which is dispersed in the matrix.

### CROSS-REFERENCE TO RELATED APPLICATION

This application claims the benefit of priority to Korean Patent Application No. 10-2024-0182970, filed in the Korean Intellectual Property Office on Dec. 10, 2024, and Korean Patent Application No. 10-2025-0076704, filed in the Korean Intellectual Property Office on Jun. 11, 2025, the entire contents of which are incorporated herein by reference.

### TECHNICAL FIELD

The present disclosure relates to an electrode that may be stably driven without short-circuiting at a room temperature and have excellent durability characteristics, a method for manufacturing the same, and an anode-less all-solid-state battery comprising the electrode.

### BACKGROUND

Various batteries are being studied to overcome the limitations of current lithium secondary batteries in terms of battery capacity, stability, output, large-scale development, and miniaturization. For example, an all-solid-state battery-generally a battery that replaces the electrolyte used in existing lithium secondary batteries with a solid—are being developed. As an all-solid-state does not use a flammable solvent it has little or no risk of ignition or explosion due to decomposition reactions that can be associated with existing state of the art electrolytes, which significantly improves safety.

Typically, an all-solid-state battery includes a stack structure including a cathode and an anode, and a solid electrolyte layer that is interposed between the cathode and the anode. Unlike lithium-ion batteries, which transfer lithium ions through contact between the electrolyte and the active material, an all-solid-state battery transfers lithium through contact between the solid electrolyte and the solid active material, and thus, to optimize the lithium-ion transfer path, the contact between the solid components should be maximized.

Recently, research has explored an anode-less type of storage method that removes the anode of the all-solid-state battery and deposits lithium directly on the anode current collector.

### SUMMARY

The present disclosure addresses the above-mentioned problems occurring in the prior art (among others) while also maintaining the advantages that have been achieved by the state of the art technology.

An aspect of the present disclosure provides an electrode and anode-less all-solid-state battery that may be stably driven without short-circuiting, (e.g., even at a room temperature) by providing a sufficient lithium ion diffusion coefficient during charge and discharge of the all-solid-state battery.

Another aspect of the present disclosure provides an electrode and/or an anode-less all-solid-state battery having excellent durability characteristics which, in some embodiments, are characterized by a volume expansion alleviation effect through inducing uniform deposition of lithium ions at an interface of an intermediate layer.

It should be appreciated that the technical problems addressed by the present disclosure are not limited to the aforementioned problems, and any other technical problems that are addressed by the various aspects and embodiments of the disclosure that are not mentioned herein specifically will be understood from the following description by those skilled in the art to which the present disclosure pertains.

In various aspects, the present disclosure provides an electrode, a method for manufacturing the same, and an anode-less all-solid-state battery comprising the same.

According to an aspect of the present disclosure, an electrode comprises a current collector, and an intermediate layer disposed on the current collector, wherein the intermediate layer comprises a matrix comprising a carbon material, a lithium-alloyable metallic element, a lithium-alloyable metalloid element, or a combination thereof, which is dispersed in the matrix; and a lithium-alloyable metal lithium-alloyable metal fluoride, a lithium-alloyable metalloid oxide, a lithium-alloyable metalloid fluoride, or a combination thereof, which is dispersed in the matrix.

In some embodiments, the carbon material may be any one or more of the materials selected from the group consisting of carbon black, acetylene black, Ketjen black, panel black, furnace black, lamp black, thermal black, natural graphite, artificial graphite, graphene, fullerene (C₆₀), single-walled carbon nanotubes, multi-walled carbon nanotubes, vapor-grown carbon fibers, carbon felt, and carbon paper.

In some embodiments, the carbon material may comprise amorphous carbon.

In some embodiments, the lithium-alloyable metallic element, the lithium-alloyable metalloid element, or the combination thereof may be one or more of the materials selected from the group consisting of Ag, Mg, Zn, Au, Sn, Ge, In, Si, Ga, Al, Sb, Pb, Bi, and Cd.

In some embodiments, the lithium-alloyable metal oxide, the lithium-alloyable metal fluoride, the lithium-alloyable metalloid oxide, the lithium-alloyable metalloid fluoride or the combination thereof may be an oxide or a fluoride, in which one or more of the metallic element or metalloid element is selected from the group consisting of Ag, Mg, Zn, Au, Sn, Ge, In, Si, Ga, Al, Sb, Pb, Bi, and Cd. In some embodiments the one or more metallic element or metalloid element in the oxide or fluoride is stoichiometrically composed.

In some embodiments, the carbon material may have an average particle diameter larger than an average particle diameter of particles that comprise the lithium-alloyable metallic element, the lithium-alloyable metalloid element, or the combination thereof; and/or particles that comprise the lithium-alloyable metal oxide, the lithium-alloyable metal fluoride, the lithium-alloyable metalloid oxide, the lithium-alloyable metalloid fluoride, or the combination thereof.

In some embodiments, the carbon material may comprise carbon material having an average particle diameter of 1 nm or more and 100 μm or less.

In some embodiments, an average particle diameter of particles comprised in the lithium-alloyable metallic element, the lithium-alloyable metalloid element, or the combination thereof may be 1 nm or more and 100 μm or less.

In some embodiments, an average particle diameter of particles comprised in the lithium-alloyable metal oxide, the lithium-alloyable fluoride, the lithium-alloyable metalloid oxide, the lithium-alloyable fluoride, or the combination thereof may be 1 nm or more and 100 μm or less.

In some embodiments, the intermediate layer may comprise the metallic element, the metalloid element or the combination thereof; and the metal oxide, the metal fluoride, the metalloid oxide, the metalloid fluoride or the combination thereof at a content of more than 0 wt % and 50 wt % or less.

In some embodiments, the intermediate layer may comprise the metallic element, the metalloid element or the combination thereof; and the metal oxide, the metal fluoride, the metalloid oxide, the metalloid fluoride or the combination thereof at a weight ratio of 1 0.1 to 9.

In some embodiments, the intermediate layer may comprise a matrix comprising amorphous carbon, Ag dispersed in the matrix, and ZnO dispersed in the matrix.

In some embodiments, the intermediate layer may further comprise Li₂O dispersed in the matrix, and LiₓZn dispersed in the matrix, wherein 0≤x≤1.

In some embodiments, the electrode may have a thickness of 1 μm or more and 100 μm or less.

According to another aspect, the disclosure provides an electrode comprising a current collector, and an intermediate layer disposed on the current collector, wherein the intermediate layer comprises a matrix comprising a carbon material, a lithium-alloyable metallic element, a lithium-alloyable metalloid element, or a combination thereof, and which is dispersed in the matrix; and Li₂O dispersed in the matrix.

According to another aspect, the present disclosure provides a method for manufacturing an electrode comprising preparing a slurry by mixing a carbon material, an inorganic element, an inorganic compound, a binder, and a solvent (S10); applying the slurry to at least one surface of a current collector (S20); and drying the slurry (S30). In embodiments, the inorganic element comprises a lithium-alloyable metallic element, a lithium-alloyable metalloid element, or a combination thereof; and the inorganic compound comprises a lithium-alloyable metal oxide, a lithium-alloyable metal fluoride, a lithium-alloyable metalloid element, a lithium-alloyable metalloid fluoride, or a combination thereof.

According to another aspect, the present disclosure provides an anode-less all-solid-state battery that comprises a cathode, an anode, and a solid electrolyte layer disposed between the cathode and the anode, wherein the cathode comprises a layer comprising a cathode active material, wherein the anode comprises the above-described electrode, and wherein the solid electrolyte layer is disposed between the layer comprising cathode active material and the intermediate layer.

In some embodiments, the cathode active material may comprise a lithium transition metal complex oxide.

In some embodiments, the solid electrolyte layer may comprise a sulfide solid electrolyte.

In some further embodiments, the sulfide solid electrolyte may comprise an argyrodite-type sulfide solid electrolyte.

In accordance with the battery of the aspects and embodiments described above and herein, when charged 100 times or more, a precipitate comprising at least one of lithium and/or Ag may form (i.e., be present) between the intermediate layer and the current collector.

In some further embodiments, when the anode-less all-solid-state battery is charged 100 times or more, the anode may comprise a thickness of 5 μm or more and 100 μm or less.

### BRIEF DESCRIPTION OF THE DRAWINGS

The above and other objects, features and advantages of the present disclosure will be more apparent from the following detailed description taken in conjunction with the accompanying drawings:

FIG. 1 illustrates an electrode according to embodiments of the present disclosure;

FIG. 2 illustrates an anode-less all-solid-state battery according to embodiments of the present disclosure;

FIG. 3A is a graph illustrating a capacity retention rate depending on charge and discharge cycles for an anode-less all-solid-state battery of an embodiment of the disclosure;

FIG. 3B is a graph illustrating a capacity retention rate depending on charge and discharge cycles for an anode-less all-solid-state battery in accordance with Comparative Example 1;

FIG. 3C is a graph illustrating a capacity retention rate depending on charge and discharge cycles for an anode-less all-solid-state battery in accordance with Comparative Example 2;

FIG. 4A is a graph depicting an analysis of a composition of a surface of a carbon area before driving through an XPS measurement in relation to a carbon area comprised in an anode-less all-solid-state battery in accordance with an embodiment of the disclosure;

FIG. 4B is a graph depicting an analysis of a composition of a surface of a carbon area before driving through an XPS measurement in relation to a carbon area comprised in an anode-less all-solid-state battery in accordance with an embodiment of the disclosure;

FIG. 4C is a graph depicting an analysis of a composition of a surface of a carbon area before driving through an XPS measurement in relation to a carbon area comprised in an anode-less all-solid-state battery in accordance with an embodiment of the disclosure;

FIG. 4D is a graph depicting an analysis of a composition of a surface of a carbon area in an initial charged state through an XPS measurement in relation to a carbon area comprised in an anode-less all-solid-state battery in accordance with an embodiment of the disclosure;

FIG. 4E is a graph depicting an analysis of a composition of a surface of a carbon area in an initial charged state through an XPS measurement in relation to a carbon area comprised in an anode-less all-solid-state battery in accordance with an embodiment of the disclosure;

FIG. 4F is a graph depicting an analysis of a composition of a surface of a carbon area in an initial charged state through an XPS measurement in relation to a carbon area comprised in an anode-less all-solid-state battery in accordance with an embodiment of the disclosure;

FIG. 4G is a graph depicting an analysis of a composition of a surface of a carbon area in a discharged state through an XPS measurement in relation to a carbon area comprised in an anode-less all-solid-state battery in accordance with an embodiment of the disclosure;

FIG. 4H is a graph depicting an analysis of a composition of a surface of a carbon area in a discharged state through an XPS measurement in relation to a carbon area comprised in an anode-less all-solid-state battery in accordance with an embodiment of the disclosure;

FIG. 4I is a graph depicting an analysis of a composition of a surface of a carbon area in a discharged state through an XPS measurement in relation to a carbon area comprised in an anode-less all-solid-state battery in accordance with an embodiment of the disclosure;

FIG. 5A is a graph depicting changes in current and voltage values when current is applied during measurement of a lithium ion diffusion coefficient through a galvanostatic intermittent titration technique (GITT);

FIG. 5B is a graph depicting voltage values over time when a current is applied to electrodes of a manufacturing example 1 and electrodes of a second comparative manufacturing example in accordance with embodiments of the disclosure;

FIG. 5C is a graph depicting a lithium ion diffusion coefficient (DLi) depending on a voltage for an electrode of a manufacturing example 1 in accordance with an embodiment of the disclosure;

FIG. 5D is a graph depicting a lithium ion diffusion coefficient (DLi) depending on a voltage for an electrode in accordance with a comparative manufacturing example;

FIG. 6A is a graph depicting a voltage and a current depending on a scan speed of an electrode in accordance with manufacturing example 1;

FIG. 6B is a graph depicting a current density depending on a scan speed of an electrode in accordance with manufacturing example 1;

FIG. 6C is a graph depicting a current density depending on a scan speed of an electrode in accordance with manufacturing example 1;

FIG. 6D is a graph depicting a voltage and a current depending on a scan speed of an electrode in accordance with a second comparative manufacturing example;

FIG. 6E is a graph depicting a current density depending on a scan speed of an electrode in accordance with a second comparative manufacturing example;

FIG. 6F is a graph depicting a current density depending on a scan speed of an electrode in accordance with a second comparative manufacturing example;

FIG. 7A is a graph depicting voltage values over time when a current is applied to an anode-less all-solid-state battery of a manufacturing example 1 and an anode-less all-solid-state battery in accordance with Comparative Example 2;

FIG. 7B is a graph depicting relaxation voltage values depending on a voltage of an anode-less all-solid-state battery of a manufacturing example 1 and an anode-less all-solid-state battery in accordance with Comparative Example 2;

FIG. 8A is a photograph of an initial state of an anode-less all-solid-state battery in accordance with a first embodiment, taken through an SEM image;

FIG. 8B is a photograph of a cross section of an anode-less all-solid-state battery in accordance with a first embodiment in a fully charged state taken through an SEM image;

FIG. 9A is a graph depicting rate characteristics depending on a charge/discharge rate of an anode-less all-solid-state battery in accordance with Examples 1 and 2 of the present disclosure;

FIG. 9B is a graph depicting rate characteristics depending on a charge/discharge rate of an anode-less all-solid-state battery in accordance with Examples 1 and 3 of the present disclosure;

FIG. 9C is a graph depicting rate characteristics depending on a charge/discharge rate of an anode-less all-solid-state battery manufactured in accordance with embodiments (e.g., first and fourth embodiments) of the present disclosure; and

FIG. 9D is a graph depicting rate characteristics depending on a charge/discharge rate of an anode-less all-solid-state battery in accordance with Examples 1 and 5 of the present disclosure.

### DETAILED DESCRIPTION

Hereinafter, the present disclosure will be described in more detail to help understanding of the present disclosure.

The above aspects, embodiments, and other objects, features and advantages of the present disclosure will be more clearly understood from the following aspects and embodiments taken in conjunction with the accompanying drawings. However, neither the present disclosure nor the claims are limited to the embodiments disclosed herein, and may be modified into different forms in accordance with the guidance provided herein. The example aspects and embodiments are provided herein in an effort to thoroughly explain the various features of the disclosure and to convey the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise” or “comprising”, “include” or “including”, “have” or “having”, etc., when used in this specification, specify the presence of stated features, integers, steps, operations, elements, components, or combinations thereof, but do not preclude the presence or addition of one or more other features, integers, steps, operations, elements, components, or combinations thereof. In some aspects and embodiments, these terms should be understood to encompass the terms “consisting of” and “consisting essentially of” which refer to features, integers, numbers, steps, operations, elements, components, parts, or combinations thereof that only include the recited components, or the recited components allowing for minor amounts of other components or elements that do not have a material effect on the function of the recited feature, component, embodiment, or aspect of the disclosure. Thus, some aspects and embodiments may refer to these various transitionary terms, all of which form part of the disclosure.

Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

Furthermore, unless specifically stated otherwise, the term “about” as used or implied herein may be understood within a range of error that is typical in the art (e.g., within 2 standard deviations of the mean). “About” may be understood as within 10%, 9%, 8%, 7%, 6%, 5%, 4%, 3%, 2%, 1%, 0.5%, 0.1%, 0.05%, or 0.01% of the stated value.

Hereinafter, embodiments will be described in detail so that a person having an ordinary skill in the art may more clearly understand and easily practice the present technology. However, the disclosure may be embodied in many different forms and should not be construed as limited to the particular embodiments as set forth herein.

### Electrode

The present disclosure provides an electrode 10 comprising a current collector, and an intermediate layer 12 that is disposed on the current collector 11, wherein the intermediate layer 12 comprises a matrix comprising a carbon material, a lithium-alloyable metallic element, a lithium-alloyable metalloid element, or a combination thereof, which is dispersed in the matrix; and a lithium-alloyable metal oxide, a lithium-alloyable metal fluoride, a lithium-alloyable metalloid oxide, a lithium-alloyable metalloid fluoride, or a combination thereof, which is dispersed in the matrix.

In another aspect, the present disclosure provides an electrode 10 comprising a current collector 11, and an intermediate layer 12 that is disposed on the current collector 11, wherein the intermediate layer 12 comprises a matrix comprising a carbon material, a lithium-alloyable metallic element, a lithium-alloyable metalloid element, or a combination thereof, which is dispersed in the matrix; and Li₂O dispersed in the matrix.

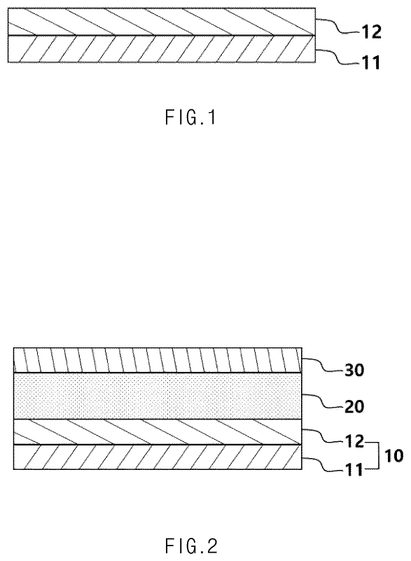

FIG. 1 illustrates an electrode 10 according to aspects and embodiments of the present disclosure. In FIG. 1, the electrode 10 may comprise a structure, wherein the current collector 11 and the intermediate layer 12 are stacked. In some embodiments, the electrode structure can comprise other configurations comprising additional layer(s) that may be included within, on, or under the stacked current collector and intermediate layer.

In some embodiments, the electrode 10 may be an anode.

In some embodiments, the electrode 10 may have a thickness of 1 μm or more, 3 μm or more, 5 μm or more, 7 μm or more, 9 μm or more, 11 μm or more, 13 μm or more, 15 μm or more; and, in some embodiments, the thickness of the electrode may be 100 μm or less, 90 μm or less, 80 μm or less, 70 μm or less, 60 μm or less, 50 μm or less, 40 μm or less, or 30 μm or less.

According to an embodiment of the present disclosure, the current collector 11 serves (i.e., is configured) to collect currents such that electrons may move to an external circuit of a battery, and comprises a high electrical conductivity so that the electrons may move quickly. In some additional embodiments, the current collector 11 may serve as an anode current collector in an interior of an anode-less all-solid-state battery.

In some embodiments, the current collector 11 may be a plate-shaped substrate having an electrical conductivity. In some specific embodiments, the current collector 11 may have the form of a sheet, a thin film, or a foil. In additional embodiments, the type of the current collector 11 may comprise a conductive material that does not trigger or cause a chemical change in the battery. In some non-limiting embodiments, the conductive material may comprise at least one of copper, stainless steel, aluminum, nickel, titanium, calcined carbon, copper or stainless steel that is surface-treated with carbon, nickel, titanium, silver, or the like, and/or an aluminum-cadmium alloy.

According to an embodiment of the present disclosure, the thickness of the current collector 11 may be 1 μm or more, 2 μm or more, 3 μm or more, 4 μm or more, 5 μm or more; and in some embodiments may be 50 μm or less, 40 μm or less, 30 μm or less, 20 μm or less, or 10 μm or less.

According to an embodiment of the present disclosure, the intermediate layer 12 may serve as a flow path or medium, through which lithium ions that are introduced from a cathode active material layer pass. In further embodiments the intermediate layer can also act as an interfacial protective film by maintaining an interfacial surface contact with a solid electrolyte layer 20 during charging and discharging of the anode-less all-solid-state battery.

In some embodiments, the intermediate layer 12 may be disposed on the current collector 11. In some non-limiting embodiments, the intermediate layer 12 may comprise a matrix comprising a carbon material, a lithium-alloyable metallic element, a lithium-alloyable metalloid element, or a combination thereof, which is dispersed in the matrix; and a lithium-alloyable metal oxide, a lithium-alloyable metal fluoride, a lithium-alloyable metalloid oxide, a lithium-alloyable metalloid fluoride, or a combination thereof, which is dispersed in the matrix. In some further non-limiting embodiments, the intermediate layer 12 may further comprise Li₂O dispersed in the matrix; and LiₓZn dispersed in the matrix, wherein, 0≤x≤1.

In some embodiments, the matrix can comprise an empty space (i.e., void volume) between the carbon materials comprised in the matrix. In such embodiments, a material having a relatively small particle diameter may be dispersed and disposed in a portion or all the empty space. In some embodiments, when the anode-less all-solid-state battery is charged, lithium ions and carbon atoms comprised in the matrix can bind to each other, and lithium may be deposited on the matrix. In some further non-limiting embodiments, the carbon material in the matrix may comprise a material comprising a carbon element. In some particular embodiments the carbon element may comprise at least one of carbon black, acetylene black, Ketjen black, panel black, furnace black, lamp black, thermal black, natural graphite, artificial graphite, graphene, fullerene (C₆₀), single-walled carbon nanotubes, multi-walled carbon nanotubes, vapor-grown carbon fibers, carbon felt, and carbon paper. In a non-limiting preferred embodiment, the carbon material may comprise acetylene black. In another non-limiting preferred embodiment, the carbon material may comprise amorphous carbon. In embodiments wherein the matrix comprises amorphous carbon, the material may serve as an interfacial protective film that prevents a direct contact between the deposited lithium and the solid electrolyte during charging and discharging, providing for stable driving without a short circuit even at a room temperature, which improves overall longevity and durability.

In an embodiment, the metallic element, the metalloid element, or the combination thereof, which is dispersed in the matrix, may be alloyed with lithium. In a non-limiting examples, the metallic element may be at least one of Ag, Mg, Zn, Au, Sn, Ge, In, Si, Ga, Al, Sb, Pb, Bi and Cd. In some further embodiments, the metallic element may be Ag. In embodiments wherein the metallic element, the metalloid element, or the combination thereof may be alloyed with lithium, the metallic element or the metalloid element may form a lithium-metal alloy (MₓLi) with Li and remain in the pores of the carbon matrix. This configuration allows for precipitation of a lithium layer to be uniformly formed between the intermediate layer and the current collector.

In an embodiment, the metal oxide, the metal fluoride, the metalloid oxide, the metalloid fluoride or the combination thereof dispersed in the matrix may be alloyed with lithium. In some non-limiting embodiments, an oxide or fluoride can include one or more metallic elements or metalloid elements of Ag, Mg, Zn, Au, Sn, Ge, In, Si, Ga, Al, Sb, Pb, Bi and Cd may be stoichiometrically composed. In some specific embodiments the metallic oxide may be Zno. When the intermediate layer comprises the metal oxide, the metal fluoride, the metalloid oxide, the metalloid fluoride or the combination thereof, the configuration can induce uniform deposition of lithium ions in the pores within the matrix while providing a movement path for lithium ions.

In embodiments, Li₂O dispersed in the matrix may be formed through a reaction between lithium ions and the metal oxide, the metal fluoride, the metalloid oxide, or the metalloid fluoride during charging, and LiₓZn dispersed in the matrix (wherein x is 0≤x≤1) may be formed through a reaction between Zn and lithium.

In some non-limiting embodiments, within the matrix, the lithium-alloyable metallic element, the lithium-alloyable metalloid element, or the combination thereof, and the lithium-alloyable metal oxide, the lithium-alloyable metal fluoride, the lithium-alloyable metalloid oxide, the lithium-alloyable metalloid fluoride, or the combination thereof may be dispersed and disposed together. When disposed as above, typically a lithium-metal alloy (MₓLi) and lithium oxide (Li₂O) are formed through a reaction with lithium ions introduced from the cathode active material layer during charging, and a metallic element and lithium ions are formed through a reverse reaction during discharging. Due to the electrochemical reaction, lithium ions can easily diffuse into the electrode during charging and discharging, and lithium ions may be uniformly deposited and desorbed into and from the pores within the matrix.

In some embodiments, the above carbon material may have an average particle diameter that is larger than the average particle diameter of particles comprised in the metallic element, the metalloid element or the combination thereof, and/or particles comprised in the metal oxide, the metal fluoride, the metalloid oxide, the metalloid fluoride or the combination thereof. Without being limited by theory or mechanism, the difference between the average particle sizes-particles comprised in the metallic element, the metalloid element, or the combination thereof having relatively small average particle sizes; and particles comprised in the metal oxide, the metal fluoride, the metalloid oxide, the metalloid fluoride, or the combination thereof that may be uniformly distributed in the empty space between the carbon materials,—lithium alloy formation reactions are sequentially reversibly performed depending on a reactivity while reacting with lithium ions in the empty space between the carbon materials. Thus, lithium ions can exhibit excellent lithium diffusion kinetics even at a room temperature, and lithium ions are evenly deposited/desorbed without short circuits even when charge/discharge cycles are performed, so that battery lifespan and durability characteristics may be improved.

In some embodiments, the carbon material may include carbon materials having an average particle diameter of greater than or equal to 1 nm, 3 nm, 5 nm, 7 nm, 9 nm, 11 nm, 13 nm, 15 nm, 17 nm, 19 nm, 21 nm, 23 nm, 25 nm, 27 nm, 29 nm, 31 nm, 33 nm, or 35 nm; and, in some embodiments, may include carbon materials having an average particle diameter of less than or equal to 100 μm, 90 μm, 80 μm, 70 μm, 60 μm, 50 μm, 40 μm, 30 μm, μm, 10 μm, 5 μm, 2 μm, 1 μm, 800 nm, 600 nm, 400 nm, 200 nm, 100 nm, 90 nm, 80 nm, 70 nm, 60 nm, or 50 nm. In embodiments 20 falling with the above-described range, the characteristics regarding discharge capacity and output may be further improved.

In some embodiments, the metal element alloyable with lithium, the metalloid element alloyable with lithium, or a combination thereof may have an average particle diameter of greater than or equal to 1 nm, 2 nm, 4 nm, 6 nm, 8 nm, 10 nm, 12 nm, 14 nm, 16 nm, 18 nm, 20 nm, 22 nm, 24 nm, 26 nm, 28 nm, or nm; and, in some embodiments, may have an average particle diameter of less than or equal to 100 μm, 90 μm, 80 μm, 70 μm, 60 μm, 50 μm, 40 μm, 30 μm, 20 μm, 10 μm, 5 μm, 2 μm, 1 μm, 900 nm, 800 nm, 700 nm, 600 nm, 500 nm, 400 nm, 300 nm, 200 nm, 100 nm, 90 nm, 80 nm, 70 nm, 60 nm, or 50 nm. In embodiments falling within the above-described range, the characteristics regarding discharge capacity and output may be further improved.

In some embodiments, the metal oxide alloyable with lithium, the metal fluoride alloyable with lithium, the metalloid oxide alloyable with lithium, the metalloid fluoride alloyable with lithium, or a combination thereof may have an average particle diameter of greater than or equal to 1 nm, 2 nm, 4 nm, 6 nm, 8 nm, 10 nm, 12 nm, 14 nm, 16 nm, 18 nm, 20 nm, 22 nm, 24 nm, 26 nm, 28 nm, or 30 nm; and, in some embodiments, may have an average particle diameter of less than or equal to 100 μm, 90 μm, 80 μm, 70 μm, 60 μm, 50 μm, 40 μm, 30 μm, 20 μm, 10 μm, 5 μm, 2 μm, 1 μm, 900 nm, 800 nm, 700 nm, 600 nm, 500 nm, 400 nm, 300 nm, 200 nm, 100 nm, 90 nm, 80 nm, 70 nm, 60 nm, or 50 nm. In embodiments falling within the above-described range, the characteristics regarding discharge capacity and output may be further improved.

In some embodiments, the intermediate layer may comprise the metallic element, the metalloid element or the combination thereof, and the metal oxide, the metal fluoride, the metalloid oxide, the metalloid fluoride or the combination thereof at a content of more than 0 wt %, 5 wt % or more, 10 wt % or more, 15 wt % or more, 20 wt % or more, 25 wt % or more; and in some embodiments may comprise the metallic element, the metalloid element or the combination thereof, and the metal oxide, the metal fluoride, the metalloid oxide, the metalloid fluoride or the combination thereof at a content of 50 wt % or less, 45 wt % or less, 40 wt % or less, 35 wt % or less, or 30 wt % or less. In embodiments falling within the above ranges, the intermediate layer comprises a sufficient amount of metallic elements, metalloid elements, metal oxides, metal fluorides, metalloid oxides or metalloid fluorides that are distributed in the empty space between the carbon materials, and that can activate and allow for the lithium alloy formation reaction.

In some embodiments, the intermediate layer may comprise the metallic element, the metalloid element or the combination thereof, and the metal oxide, the metal fluoride, the metalloid oxide, the metalloid fluoride or the combination thereof at a weight ratio of 1:0.1 to 9, and, in further embodiments, may comprise the metal oxide, the metal fluoride, or the combination thereof, and the metalloid oxide, the metalloid fluoride or the combination thereof at a weight ratio of 1:0.1 to 5. In embodiments falling within these weight ratios, the metallic element, the metalloid element, or the combination thereof, and the metal oxide, the metal fluoride, the metalloid oxide, the metalloid fluoride, or the combination thereof are distributed at an appropriate ratio into the empty space between the carbon materials, and can activate the lithium alloy formation reaction.

### Method for Manufacturing Electrode

In an aspect, the disclosure provides a method for manufacturing an electrode according to the present disclosure, and comprises manufacturing slurry by mixing a carbon material, an inorganic element, an inorganic compound, a binder, and a solvent (S10); applying the slurry to at least any one surface of a current collector (S20); and drying the slurry (S30).

In embodiments of the method (e.g., S10), the inorganic element may comprise a lithium-alloyable metallic element, a lithium-alloyable metalloid element, or a combination thereof, and the inorganic compound may comprise a lithium-alloyable metal oxide, a lithium-alloyable metal fluoride, a lithium-alloyable metalloid oxide, a lithium-alloyable metalloid fluoride, or a combination thereof.

In embodiments of the method (e.g., S10), the carbon material, the lithium-alloyable metallic element, the lithium-alloyable metalloid element, or the combination thereof comprised in the inorganic element, and the lithium-alloyable metal oxide, the lithium-alloyable metal fluoride, the lithium-alloyable metalloid oxide, the lithium-alloyable metalloid fluoride, or the combination thereof comprised in the inorganic compound may be applied as described above.

In embodiments, the binder may be a polymer binder that does not react with inorganic elements and inorganic compounds. For example, the binder may comprise polyvinylidene fluoride (PVDF), carboxymethyl cellulose (CMC), polyethylene oxide (PEO), polymethylmethacrylate (PMMA), polytetrafluoroethylene (PTFE), and the like.

In accordance with the method, any solvent may be used as long as it may dissolve the carbon material, the inorganic element, the inorganic compound, and the binder. In some non-limiting examples, the solvent may comprise water, acetone, ethanol, N-methyl pyrrolidone (NMP), dimethyl sulfoxide (DMSO), tetrahydrofuran (THF), and the like.

When the slurry is manufactured, the order of introduction of the carbon material, the inorganic element, the lithium-alloyable metal oxide, the lithium-alloyable metal fluoride, the lithium-alloyable metalloid oxide, the lithium-alloyable metalloid fluoride, or the combination thereof, the binder, and the solvent comprised in the slurry as described in the method (e.g., operation S10) may be introduced simultaneously, sequentially, or at different times.

In the method (e.g., operation S20), the slurry may be applied to at least one surface of the current collector, and in some embodiments, may be applied to opposite surfaces of the current collector. In some non-limiting examples, the application may be performed by any method selected from use of a doctor blade, die casting, comma coating, screen printing, spray coating, electrospinning, roll coating, and brushing.

In the method (e.g., operation S30), the drying process may be comprise drying the applied layer to evaporate the solvent to form an intermediate layer, and may be performed by any technique such as, for example, air drying, oven drying, vacuum drying, or microwave drying. In some embodiments, the drying may be performed in a temperature range of 70° C. or higher, 75° C. or higher, 80° C. or higher, 85° C. or higher, 90° C. or higher, 95° C. or higher, and 100° C. or higher, and, in some embodiments, may be performed in a temperature range of 150° C. or lower, 145° C. or lower, 140° C. or lower, 135° C. or lower, 130° C. or lower, 125° C. or lower, and 120° C. or lower. Within these temperature range, the drying may be performed uniformly, any residual solvent may be minimized, electrochemical instability may be reduced, and an intermediate layer having a uniform thickness may be obtained.

Anode-Less all-Solid-State Battery

In another aspect, the disclosure provides an anode-less all-solid-state battery that includes a cathode 30, an anode, and a solid electrolyte layer 20 that is disposed between the cathode 30 and the anode. In some embodiments, the anode-less all-solid-state battery may include a unit cell. The anode-less all-solid-state battery may refer to a unit cell itself, and may also refer to an anode-less all-solid-state battery that is formed by stacking a plurality of unit cells. The unit cell may comprise a structure in which an anode, a solid electrolyte layer, and a cathode are sequentially stacked, and, as illustrated in the example embodiment in FIG. 2, may comprise the anode, the solid electrolyte layer 20, and the cathode 30 in sequential stack, and wherein the anode may be the electrode 10 described above.

In some embodiments wherein the anode-less all-solid-state battery is charged 100 times or more, one or more of lithium and/or Ag can precipitate between the intermediate layer and the current collector. In some embodiments, the anode-less all-solid-state battery reacts with lithium ions and metal oxides, metal fluorides, metalloid oxides, metalloid fluorides, or a combination thereof during charging to form a lithium-metal alloy (MₓLi) and a lithium oxide (Li₂O), and which can precipitate lithium ions between the intermediate layer and the current collector. In some further embodiments, as charge and discharge progress, some of the Ag dispersed in the matrix of the intermediate layer 12 may move to the lithium precipitation layer and may be present between the intermediate layer 12 and the current collector 11.

In some embodiments wherein the anode-less all-solid-state battery is charged 100 times or more, the thickness of the anode may be 5 μm or more, 7 μm or more, 9 μm or more, 11 μm or more, 13 μm or more, 15 μm or more, 17 μm or more, or 19 μm or more, and, in some embodiments, may be 100 μm or less, 90 μm or less, 80 μm or less, 70 μm or less, 60 μm or less, 50 μm or less, 40 μm or less, or 30 μm or less.

According to one embodiment of the present disclosure, the anode may be the electrode 10 described above.

According to one embodiment of the present disclosure, the solid electrolyte layer 20 may serve as a movement path (or flow path) for lithium ions, and may be disposed between the cathode active material layer and the intermediate layer. In some further embodiments, the solid electrolyte layer 20 may comprise a solid electrolyte and a binder. In some further embodiments, the solid electrolyte may comprise a material having a lithium ion conductivity, and in some non-limiting embodiments, may comprise at least any one of an oxide-based solid electrolyte, a sulfide solid electrolyte, a polymer electrolyte, and/or a combination thereof. In some specific embodiments, the solid electrolyte, may comprise a sulfide solid electrolyte. In such embodiments, the sulfide solid electrolyte can comprise a high lithium ion conductivity, and thus, may be particularly suitable as a solid electrolyte.

In some embodiments, the sulfide solid electrolyte may comprise at least one of an LPS-based solid electrolyte, a Thio-LISICON-based solid electrolyte, an LGPS-based solid electrolyte, and an argyrodite-type sulfide solid electrolyte. In some further embodiments, it may comprise an argyrodite-type sulfide solid electrolyte. In some non-limiting example embodiments, the sulfide solid electrolyte may comprise at least one of Li₂S—P₂S₅, Li₂S-P₂S₅-LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—PS₅—LiI, Li₂S—B₂S₃, Li₂S—PS₅-ZmSn (where, m, n are positive numbers, and Z is one of Ge, Zn, and Ga), Li₂S—GeS₂, Li₂S—SiS₂—Li₃PO₄, Li₂S—SiS₂-LiₓMO_{y} (where, x, y are positive numbers, M is one of P, Si, Ge, B, Al, Ga, and In), LiGPS₅Cl, Li_{5.5}PS_{4.5}Cl_{1.5}, Li₆PS₅Cl_{0.5}br_{0.5} and Li₁₀GeP₂S₁₂. In some specific embodiments, the sulfide solid electrolyte may comprise at least one selected from the group consisting of LiPS₅Cl, Li_{5.5}PS_{4.5}Cl_{1.5} and Li₆PS₅Cl_{0.5}Br_{0.5}, and in some preferred embodiments, may comprise Li₆PS₅Cl_{0.5}Br_{0.5}.

In some embodiments, the above binder may comprise butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like.

The cathode 30 according to an embodiment of the present disclosure may comprise a cathode active material layer comprising a cathode active material. In embodiments, the cathode active material layer may serve to reversibly absorb and release lithium ions. In such embodiments, the cathode may be in the form of a current collector coated with a cathode active material, and the cathode active material layer may comprise a cathode active material, a solid electrolyte, a conductive material, a binder, etc.

In some further embodiments, the cathode active material may be at least one of a lithium-manganese oxide, a lithium-cobalt oxide, a lithium-nickel oxide, a lithium-nickel-manganese oxide, a lithium-nickel-cobalt oxide, a lithium-manganese-cobalt oxide, and/or a lithium-nickel-cobalt-manganese oxide.

In some specific embodiments, the cathode active material may be at least one of LiMnO₂, LiMn₂O, LiCoO₂, LiNiO₂, LiNi_{1-Y}Mn_{Y}O₂ (wherein, 0<Y<1), LiNi_{1-Y}Co_{Y}O₂ (wherein, 0<Y<1), LiMn_{2-Z}Co₂O₄ (wherein, 0<Z<2), Li(Ni_{P}Co_{Q}Mn_{R}) O₂ (wherein, 0<P<1, 0<Q<1, 0<R<1, P+Q+R=1), and/or Li(Ni_{P}CO_{Q}Mn_{R}) O₄ (wherein, 0<P<2, 0<Q<2, 0<R<2, P+Q+R=2). In some further embodiments, the cathode active material is selected the group consisting of from LiNi_{0.8}Mn_{0.2}Co_{0.2}O₂, LiNi_{0.8}Mn_{0.3}Co_{0.2}O₂, LiNi_{0.7}Mn_{0.15}Co_{0.15}O₂, and LiNi_{0.8}Mn_{0.1}Co_{0.102}, which may be selected to improve the capacity characteristics and the stability of the battery.

In embodiments, the above cathode active material may be doped with a transition metal, and may comprise at least one of Al, Mo, Nb, K, Cl, Na, Ti, Mg, Ru, Ta, Zr, W, Ti, Y, and/or B. In one non-limiting example, the cathode active material may comprise a lithium transition metal complex oxide that is represented by the following chemical formula 1.

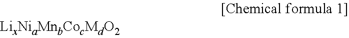

wherein,
“M” comprises at least one of Al, Mo, Nb, K, Cl, Na, Ti, Mg, Ru, Ta, Zr, W, Ti, Y and/or B; and
a+b+c+d=1, wherein 0.9<x<1.3, 0<a<1, 0<b<1, 0<c<1, and
0≤d<0.2.

In some embodiments, “a” may be greater than 0, 0.1 or more, 0.2 or more, 0.3 or more, 0.4 or more, 0.5 or more, 0.6 or more, or 0.7 or more, and in some embodiments may be less than 1, 0.95 or less, 0.9 or less, or 0.85 or less.

In some embodiments, “b” may be greater than 0, 0.01 or more, 0.02 or more, 0.03 or more, 0.04 or more, 0.05 or more, 0.06 or more, 0.07 or more, 0.08 or more, 0.09 or more, and in some embodiments less than 1, 0.9 or less, 0.8 or less, 0.7 or less, 0.6 or less, 0.5 or less, 0.4 or less, 0.3 or less, 0.2 or less.

In some embodiments, “c” may be greater than 0, 0.01 or more, 0.02 or more, 0.03 or more, 0.04 or more, 0.05 or more, 0.06 or more, 0.07 or more, 0.08 or more, 0.09 or more, and in some embodiments less than 1, 0.9 or less, 0.8 or less, 0.7 or less, 0.6 or less, 0.5 or less, 0.4 or less, 0.3 or less, 0.2 or less.

In some embodiments, “d” may be greater than 0, 0.01 or more, 0.02 or more, 0.03 or more, 0.04 or more, 0.05 or more, 0.06 or more, 0.07 or more, 0.08 or more, 0.09 or more, and in some embodiments less than 0.2, 0.19 or less, 0.18 or less, 0.17 or less, 0.16 or less, 0.15 or less, 0.14 or less, 0.13 or less, 0.12 or less, 0.11 or less.

In some embodiments, the cathode active material may comprise a coating portion that is formed on a surface. The coating portion may comprise a Li-M-O solid solution (“M” is at least one selected from Al, Mo, Nb, K, Cl, Na, Ti, Mg, Ru, Ta, Zr, W, Ti, Y, and B) on the surface of the cathode active material. In some embodiments, the Li-M-O solid solution may comprise at least one of Li—Nb—O, Li—Co —O, and Li—Ti-0. The above Li-M-O solid solution may, in some embodiments, comprise at least one of LiNbO₂, LiNbO₃, LiCoO₂, and LigTiO₃, and in some specific embodiments, may comprise at least one of LiNbO₃ and LiCoO₂. Such embodiments can provide excellent lithium ion conductivity, and electrical conductivity to the coating part comprising the Li-M-O solid solution. This can provide a lithium secondary battery having a low internal resistance.

In some embodiments, the coating portion may comprise a solid electrolyte. The solid electrolyte may comprise a material having a lithium ion conductivity, and in some non-limiting embodiments, may comprise at least one of an oxide-based solid electrolyte, a sulfide solid electrolyte, a polymer electrolyte, and/or a combination thereof. In some further embodiments the solid electrolyte may comprise a sulfide solid electrolyte. In some embodiments, the solid electrolyte may comprise a sulfide-based solid electrolyte that is represented by the following chemical formula 2.

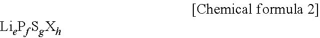

In chemical formula 2, “X” is F, Cl, Br or I, 0<e≤10, 0<f≤10, 0<g≤15, and 0≤h≤20.

In some embodiments, “e” may be greater than 0, 1 or more, 2 or more, 3 or more, 4 or more, and 5 or more, and may be 10 or less, 9, or less 8 or less, 7 or less, or 6 or less.

In some embodiments, “f” may be greater than 0, 1 or more, 2 or more, 3 or more, 4 or more, or 5 or more, and may be 10 or less, 9 or less, 8 or less, 7 or less, or 6 or less.

In some embodiments, “g” may be greater than 0, 1 or more, 2 or more, 3 or more, 4 or more, 5 or more, 6 or more, or 7 or more, and may be 15 or less, 14 or less, 13 or less, 12 or less, 11 or less, 10 or less, or 9 or less.

In some embodiments “h” may be greater than 0, 2 or more, 4 or more, 6 or more, 8 or more, or 10 or more, and may be 20 or less, 18 or less, 16 or less, 14 or less, or 12 or less.

In some embodiments, the conductive material may be carbon black, conducting graphite, ethylene black, graphene, and the like.

In some embodiments, the above binder may comprise butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like.

In some embodiments, the cathode current collector may be a plate-shaped substrate having an electrical conductivity. In some further embodiments, the cathode current collector may have the form of a sheet or a thin film. In some embodiments, the cathode current collector may comprise at least any one selected from the group consisting of indium, copper, magnesium, aluminum, stainless steel, iron, and combinations thereof.

In the following illustrative examples, the present disclosure will be described in more detail through particular embodiments. The examples are provided merely for purposes of clarifying and expanding upon particular embodiments of the present disclosure, and the scope of the present disclosure is not limited thereto.

### Manufacturing Example 1-Manufacturing Electrode including AgZnO/C Mixed Slurry

Acetylene black having an average particle diameter of 50 nm was prepared as a carbon material. Silver (Ag) nano powder having an average particle diameter of 40 nm was prepared as a metal material. Zinc oxide (ZnO) having an average particle diameter of 40 nm was prepared as a metal oxide material. The metal and the metal oxide were mixed at a weight ratio of 5:5 and introduced at 25 wt %, the carbon material was introduced at 75 wt %, and dry-milled to manufacture a mixture.

93.7 wt % of the mixture and 6.3w % of the binder (polyvinylidene fluoride, PVDF) were introduced to a solvent (N-methyl pyrrolidone, NMP) to manufacture slurry. The slurry was applied onto the current collector, and was dried at 100° C. to form an intermediate layer. Nickel foil was used as the current collector.

### Manufacturing Example 2-Manufacturing Electrode including AgZnO/C Mixed Slurry

Acetylene black having an average particle diameter of 50 nm was prepared as a carbon material. Silver (Ag) nano powder having a particle diameter of 10 nm was prepared as a metal material. Zinc oxide (ZnO) having an average particle diameter of 40 nm was prepared as a metal oxide material. The metal and the metal oxide were mixed at a weight ratio of 5:5 and introduced at 25 wt %, the carbon material was introduced at 75 wt %, and dry-milled to manufacture a mixture.

93.7 wt % of the mixture and 6.3w% of the binder (polyvinylidene fluoride, PVDF) were introduced to a solvent (N-methyl pyrrolidone, NMP) to manufacture slurry. The slurry was applied onto the current collector, and was dried at 100° C. to form an intermediate layer. Nickel foil was used as the current collector.

### Manufacturing Example 3-Manufacturing Electrode including AgZnO/C Mixed Slurry

Acetylene black having an average particle diameter of 50 nm was prepared as a carbon material. Silver (Ag) nano powder having an average particle diameter of 500 nm was prepared as a metal material. Zinc oxide (ZnO) having an average particle diameter of 40 nm was prepared as a metal oxide material. The metal and the metal oxide were mixed at a weight ratio of 5:5 and introduced at 25 wt %, the carbon material was introduced at 75 wt %, and dry-milled to manufacture a mixture.

93.7 wt % of the mixture and 6.3w% of the binder (polyvinylidene fluoride, PVDF) were introduced to a solvent (N-methyl pyrrolidone, NMP) to manufacture slurry. The slurry was applied onto the current collector, and was dried at 100° C. to form an intermediate layer. Nickel foil was used as the current collector.

### Manufacturing Example 4-Manufacturing Electrode including AgZnO/C Mixed Slurry

Acetylene black having an average particle diameter of 50 nm was prepared as a carbon material. Silver (Ag) nano powder having an average particle diameter of 40 nm was prepared as a metal material. Zinc oxide (ZnO) having an average particle diameter of 20 nm was prepared as a metal oxide material. The metal and the metal oxide were mixed at a weight ratio of 5:5 and introduced at 25 wt, the carbon material was introduced at 75 wt %, and dry-milled to manufacture a mixture.

93.7 wt % of the mixture and 6.3w% of the binder (polyvinylidene fluoride, PVDF) were introduced to a solvent (N-methyl pyrrolidone, NMP) to manufacture slurry. The slurry was applied onto the current collector, and was dried at 100° C. to form an intermediate layer. Nickel foil was used as the current collector.

### Manufacturing Example 5-Manufacturing Electrode including AgZnO/C Mixed Slurry

Acetylene black having an average particle diameter of 50 nm was prepared as a carbon material. Silver (Ag) nano powder having an average particle diameter of 40 nm was prepared as a metal material. Zinc oxide (ZnO) having an average particle diameter of 200 nm was prepared as a metal oxide material. The metal and the metal oxide were mixed at a weight ratio of 5:5 and introduced at 25 wt %, the carbon material was introduced at 75 wt %, and dry-milled to manufacture a mixture.

93.7 wt % of the mixture and 6.3w% of the binder (polyvinylidene fluoride, PVDF) were introduced to a solvent (N-methyl pyrrolidone, NMP) to manufacture slurry. The slurry was applied onto the current collector, and was dried at 100° C. to form an intermediate layer. Nickel foil was used as the current collector.

### Comparative Manufacturing Example 1-Manufacturing Electrode including AgZnO Mixed Slurry

Silver (Ag) nano powder having an average particle diameter of 40 nm was prepared as a metal material. Zinc oxide (ZnO) having an average particle diameter of 40 nm was prepared as a metal oxide material. The metal and the metal oxide were mixed at a weight ratio of 5:5, introduced at 100 wt %, and dry-milled to manufacture a mixture.

93.7 wt % of the mixture and 6.3w% of the binder (polyvinylidene fluoride, PVDF) were introduced to a solvent (N-methyl pyrrolidone, NMP) to manufacture slurry. The slurry was applied onto the current collector, and was dried at 100° C. to form an intermediate layer. Nickel foil was used as the current collector.

### Comparative Manufacturing Example 2-Manufacturing Electrode including Ag/C Mixed Slurry

Acetylene black having an average particle diameter of 50 nm was prepared as a carbon material. Silver (Ag) nano powder having an average particle diameter of 40 nm was prepared as a metal material. 25 wt % of the metal and 75 wt % of the carbon material were each put into a container and dry-milled to prepare a mixture.

93.7 wt % of the mixture and 6.3w % of the binder (polyvinylidene fluoride, PVDF) were introduced to a solvent (N-methyl pyrrolidone, NMP) to manufacture slurry. The slurry was applied onto the current collector, and was dried at 100° C. to form an intermediate layer. Nickel foil was used as the current collector.

### Example 1-Manufacturing of Anode-less All-solid-state Battery Including Electrode of Manufacturing example 1

Li₆PS₅Cl was used as a solid electrolyte contained in the cathode, LiNi_{0.8}Co_{0.1}Mn_{0.1}O₂ was used as a cathode active material, carbon black was used as a conductive material, and butadiene rubber was used as a binder, they were mixed with the solvent o-xylene to manufacture slurry for forming a cathode, and it was applied to a aluminum foil that is a cathode current collector by using a doctor blade, and then was dried at 120° C. for 10 minutes.

Next, Li₆PS₅Cl as a solid electrolyte disposed on the cathode and butadiene rubber as a binder were mixed in o-xylene as a solvent, and then applied onto the cathode and dried at 120° C. for 10 minutes to form a cathode stack part on the cathode. Afterwards, the cathode stack part was vacuum-dried at 120° C. for 4 hours.

The electrode according to the manufacturing example 1 was disposed to face an upper side, and a cathode, in which the cathode stack part is formed, was stacked so that the cathode stack part faces the electrode. Accordingly, an anode-less all-solid-state battery was manufactured through rolling under conditions of 90° C. and 450 MPa by using a warm isotactic press.

### Example 2-Manufacturing of Anode-less All-solid-state Battery Including Electrode of Manufacturing example 2

In this Example, a battery was manufactured in the same manner as in the Example 1, except that the electrode according to the manufacturing example 1 was replaced with the electrode according to the manufacturing example 2.

### Example 3-Manufacturing of Anode-less All-solid-state Battery Including Electrode of Manufacturing example 3

In this Example, a battery was manufactured in the same manner as in the Example 1, except that the electrode according to the manufacturing example 1 was replaced with the electrode according to the manufacturing example 3.

### Example 4-Manufacturing of Anode-less All-solid-state Battery Including Electrode of Manufacturing example 4

In this Example, a battery was manufactured in the same manner as in the Example 1, except that the electrode according to the manufacturing example 1 was replaced with the electrode according to the manufacturing example 4.

### Example 5-Manufacturing of Anode-less All-solid-state Battery Including Electrode of Manufacturing example 5

In this Example, a battery was manufactured in the same manner as in the Example 1, except that the electrode according to the manufacturing example 1 was replaced with the electrode according to the manufacturing example 5.

### Comparative Example 1-Manufacturing of Anode-less All-solid-state Battery Including Electrode of Comparative Manufacturing Example 1

In this Comparative Example, a battery was manufactured in the same manner as in the Example 1, except that the electrode of the manufacturing example 1 was replaced with the electrode of the Comparative Manufacturing Example 1.

### Comparative Example 2-Manufacturing of Anode-less All-solid-state Battery Including Electrode of Comparative Manufacturing Example 2

In this Comparative Example, a battery was manufactured in the same manner as in the Example 1, except that the electrode of the manufacturing example 1 was replaced with the electrode of the Comparative Manufacturing Example 2.

### First Experimental Example-Evaluation of Initial Performance and Durability Characteristics

The anode-less all-solid-state battery manufactured in the Examples 1 to 5, the Comparative Example 1, or the Comparative Example 2 was sealed under a pressure of 2.7 MPa to manufacture a pouch-type lithium secondary battery.

By using the above pouch-type lithium secondary battery, the activation process (formation) was performed by charging it to 4.25 V in CC (0.1C) mode at 30° C. and then discharging it to 2.0 V at 0.1C. Subsequently, at 30° C., one cycle including charging to 4.25V in a constant current (CC) mode at 0.33C and then discharging to 2.0V at 0.33C was performed, and the discharge capacity (mAh/g), the efficiency (%), the average discharge voltage (V), and the internal resistance were measured and are illustrated in Table 1 below.

Afterwards, 100 charge/discharge cycles were performed under the same conditions as the above charge/discharge cycles.

Furthermore, for the anode-less all-solid-state batteries manufactured in the first to Example 5, the Comparative Example 1, and the Comparative Example 2, the capacity retention rate (%) at 30, 50, and 100 charge/discharge cycles was measured, and the coulombic efficiency was calculated by using the following equation and is illustrated in Table 1 below.

$$Coulomb Efficiency ( \% ) = ( Discharge Capacity ) / ( Charge Capacity ) * 100$$

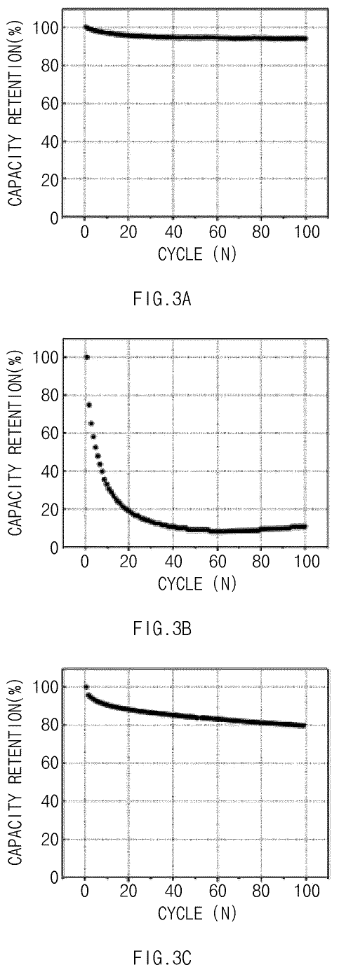

FIGS. 3A to 3C illustrate the capacity retention rate (%) depending on the number of cycles during 100 charge/discharge cycles for the anode-less all-solid-state batteries manufactured in the Example 1, the Comparative Example 1, and the Comparative Example 2.

TABLE 1

| | Initial performance | | | | | | | | | |
|---|---|---|---|---|---|---|---|---|---|---|
| | | | Average | | 30th cyc | | 50th cyc | | 100th cyc | |
| | Discharge | | Discharge | Internal | Capacity | Coulomb | Capacity | Coulomb | Capacity | Coulomb |
| | Capacity | Efficiency | voltage | resistance | retention | efficiency | retention | efficiency | retention | efficiency |
| Anode | (mAh/g) | (%) | (V) | (Ohm) | rate (%) | (%) | rate (%) | (%) | rate (%) | (%) |
| Ex. 1 | 155.8 | 92.8 | 3.75 | 4.32 | 95.0 | 100.0 | 94.4 | 100.0 | 94.0 | 99.9 |
| Ex. | 154.3 | 92.0 | 3.73 | 4.55 | 98.6 | 99.9 | 97.7 | 99.9 | 96.1 | 99.7 |
| Ex. 3 | 151.9 | 92.1 | 3.72 | 4.55 | 94.6 | 99.9 | 93.4 | 99.9 | 90.6 | 99.9 |
| Ex. 4 | 154.8 | 92.1 | 3.73 | 4.32 | 96.7 | 99.9 | 95.2 | 99.9 | 92.3 | 99.9 |
| Ex. 5 | 139.1 | 92.1 | 3.63 | 4.50 | 94.8 | 99.8 | 92.8 | 99.9 | 88.6 | 99.8 |
| Comp. | 80.5 | 67.9 | — | — | — | — | — | — | — | — |
| Ex. 1 | | | | | | | | | | |
| Comp. | 156.6 | 81.3 | 3.65 | 5.37 | 86.8 | 99.4 | 84.3 | 99.3 | 79.8 | 99.3 |
| Ex. 2 | | | | | | | | | | |

As represented in Table 1 above, it was identified that the anode-less all-solid-state battery of Examples 1-5 has an excellent efficiency due to not only a high initial discharge capacity and a high average discharge voltage but also a low internal resistance value. Through this, it was identified that complete discharge was achieved as lithium ions uniformly deposited in interiors of the matrix pores during charging were uniformly desorbed.

Furthermore, as represented in Table 1 and FIG. 3A, it was identified that the anode-less all-solid-state battery of Examples 1-5 obtains a Coulomb efficiency of 99.7% or more while maintaining a capacity retention rate of 88% or more after 100 charge/discharge cycles in terms of evaluation of durability. Through this, as the charge-discharge cycles progress, silver (Ag) and a metal oxide (ZnO) are uniformly dispersed in an interior of the matrix of the intermediate layer, so that the separation of layers between silver (Ag) and carbon was suppressed and a stable interface was maintained, and lithium was actively diffused even at a room temperature due to the lithium oxide (Li₂O) formed in the matrix, so that lithium diffusion kinetics was improved and the movement of lithium ions was active during charging/discharging, and thus, the durability and life characteristics were improved.

In contrast, it was identified that the anode-less all-solid-state battery of the Comparative Example 1 exhibited lower initial discharge capacity and efficiency, and thus, its initial performance was relatively inferior compared to the Examples 1 to 5. Furthermore, as represented in Table 1 and FIG. 3B, the anode-less all-solid-state battery of the Comparative Example 1 showed a tendency for the capacity retention rate to decrease rapidly because complete discharge was not achieved in terms of evaluation of durability, and showed a low capacity retention rate of 20% or less after about 20 charge/discharge cycles. Through this, in the case of the anode-less all-solid-state battery of the Comparative Example 1, it was identified that the interface with the solid electrolyte was separated as the lithium deposited during discharge was randomly desorbed, and that under the low clamping pressure conditions of the pouch cell unit, it was difficult for the separated interface to recover, so complete discharge was not achieved.

It was identified that the anode-less all-solid-state battery of the Comparative Example 2 had a discharge capacity and an average discharge voltage at a level that is similar to those of the Examples 1 to 5, but exhibited a higher internal resistance and thus a lower efficiency. It was identified that, as illustrated in Table 1 and FIG. 3C, the anode-less all-solid-state battery of the Comparative Example 2 exhibited a greater decrease in the capacity retention rate as the charge/discharge cycles progressed, indicating a relatively lower capacity retention rate and a coulombic efficiency compared to the anode-less all-solid-state batteries of the Examples 1 to 5, also in terms of durability evaluation. Through this, in the case of the anode-less all-solid-state battery of the Comparative Example 2, it was identified that only silver that forms a solid solution with lithium in the matrix is present, resulting in layer separation between the carbon and silver, and as a result, the lithium deposited under the carbon layer by silver has low lithium diffusion kinetics characteristics in the carbon area under room temperature conditions, so that it cannot be completely discharged and an unstable interface is formed.

### Second Experimental Example-Analysis of Surface of Matrix Using XPS Measurement

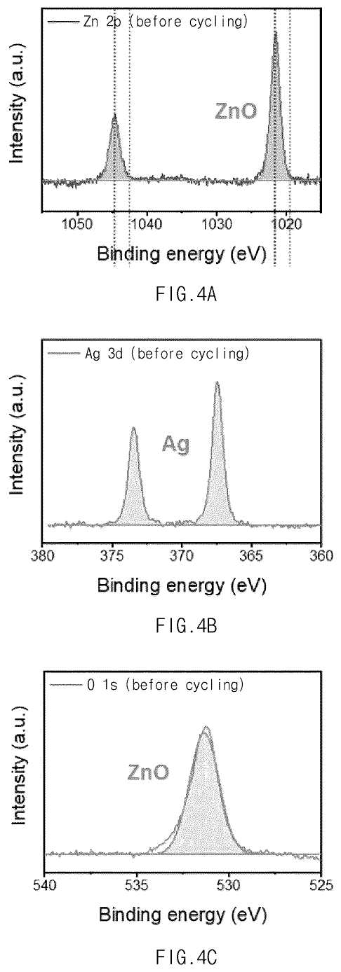

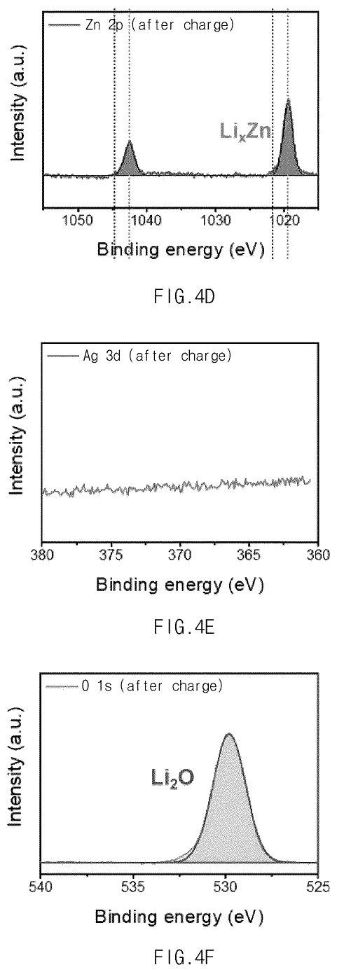

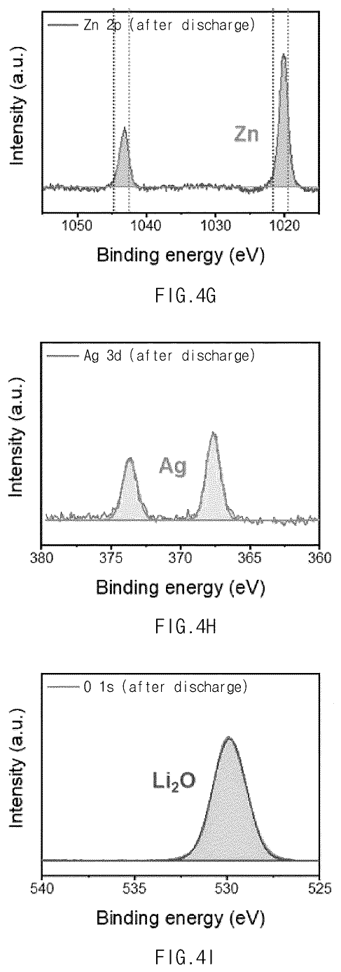

The components of the matrix surface at the initial state of charge (4.25 V, SOC 100) and a discharge state (2.5 V, SOC 0) before driving of the anode-less all-solid-state battery of the Example 1 were analyzed through XPS measurements. After fixing the anode-less all-solid-state battery of the Example 1 to a silicon wafer with a copper tape, five or more sections were scanned by using X-ray photoelectron spectroscopy (XPS), and the results are illustrated in FIGS. 4A to 4I.

As illustrated in FIGS. 4A to 41, before driving of the anode-less all-solid-state battery of the Example 1, the presence of silver (Ag) and zinc oxide (ZnO) was identified, in a charged state, lithium-zinc alloy (LiₓZn) and lithium oxide (Li₂O) were identified, but silver (Ag) was not identified, and in a discharged state, zinc (Zn), silver (Ag), and lithium oxide (Li₂O) were identified. Through this, it was identified that during charging, zinc oxide (ZnO) in the matrix reacts with lithium ions to form lithium-zinc alloy (LiₓZn) and lithium oxide (Li₂O), and silver (Ag) diffuses and moves to the lithium electrodeposition layer located under the matrix, and it was identified that during discharging, lithium-zinc alloy (LiₓZn) is separated into metallic elements, silver (Ag) diffuses and moves to the surface of the matrix, and Li₂O is an irreversible product, so it remains in the carbon layer.

### Third Experimental Example-Comparison of Lithium Ion Diffusion Coefficients (1)

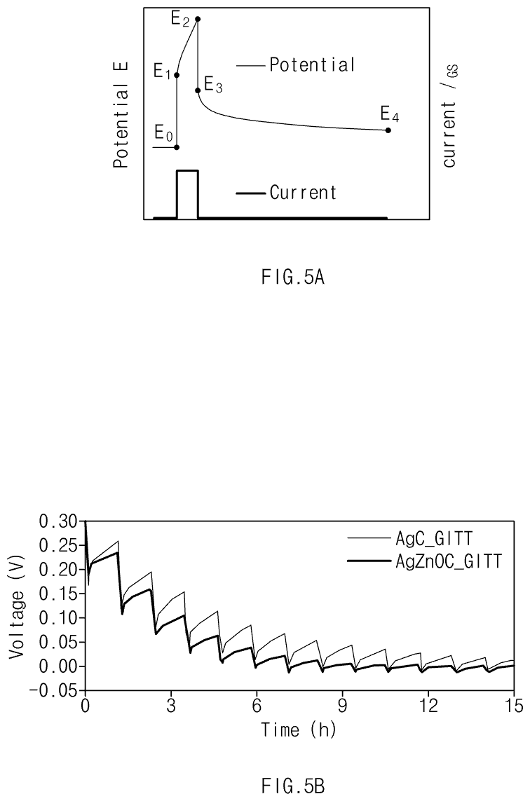

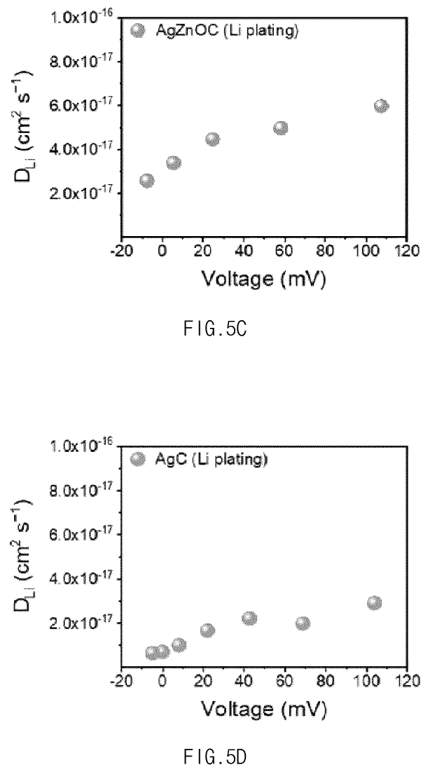

For the electrodes of the manufacturing example 1, and the electrodes of the Comparative Manufacturing Example 2, half cells were manufactured and evaluated to compare the lithium ion diffusion coefficients (DLi) of the electrodes themselves. Then, the electrodes of the present disclosure manufacturing example 1, and the Comparative Manufacturing Example 2 were used as the half cells, Li₆PS₅Cl and a lithium metal were used as the solid electrolyte, and the lithium ion diffusion coefficient (DLi) was calculated by using the galvanostatic intermittent titration technique (GITT) at 30° C., and the lithium ion diffusion coefficient (DLi) was calculated according to the following Equation 1 while referring to changes in voltage when the current of FIG. 5A was applied.

$${D}_{Li} = \frac{4}{9 π} \times {( \frac{{E}_{4} - {E}_{0}}{{E}_{2} - {E}_{1}} )}^{2} \times \frac{{r}_{p}^{2}}{{t}_{p}} \qquad [ Equation 1 ]$$

wherein,
rₚ: average particle size (50 nm)
tₚ: current application time (10 min)
E₄-E₀: difference between initial voltage and rest (steady state) voltage
E₂-E₁: difference between voltages during application of current

As illustrated in FIGS. 5B to 5D, it was identified that the voltage difference (E₂-E₁) during the application of the current in the electrode of the manufacturing example 1 was lower than that of the electrode of the Comparative Manufacturing Example 2, and accordingly, the lithium ion diffusion coefficient of the electrode of the manufacturing example 1, was improved by about 2.7 times on average compared to that of the electrode of the Comparative Manufacturing Example 2. Through this, in the case of the electrode of the manufacturing example 1, it suggests that silver (Ag) and zinc oxide (ZnO) are uniformly dispersed as dual seeds in the matrix, so that lithium ions in the matrix are uniformly deposited in the matrix pores, and a sufficient lithium ion diffusion coefficient may be secured even at a room temperature (30° C.), and thus, the battery may be stably driven without short-circuiting due to the active movement of lithium ions during charging and discharging.

### Fourth Experimental Example-Comparison of Lithium Ion Diffusion Coefficients (2)

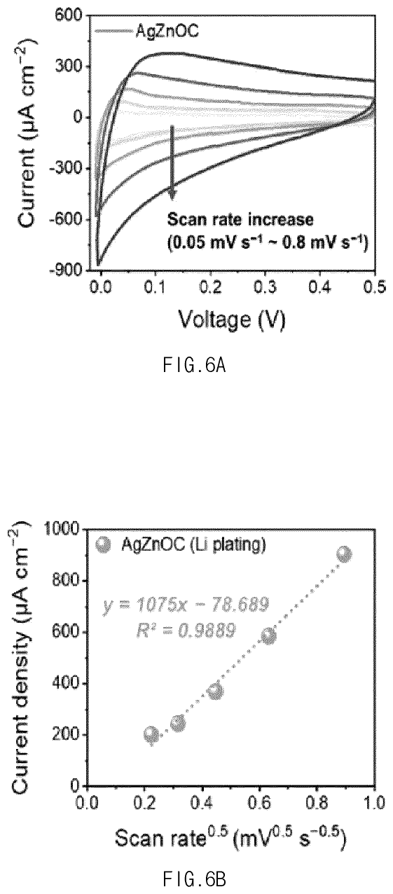

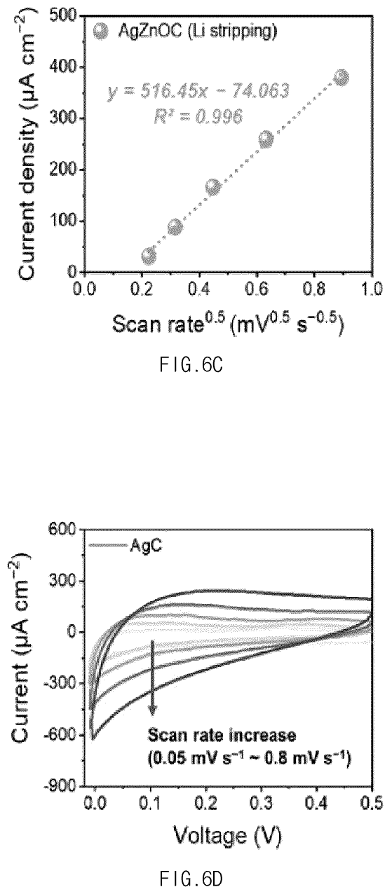

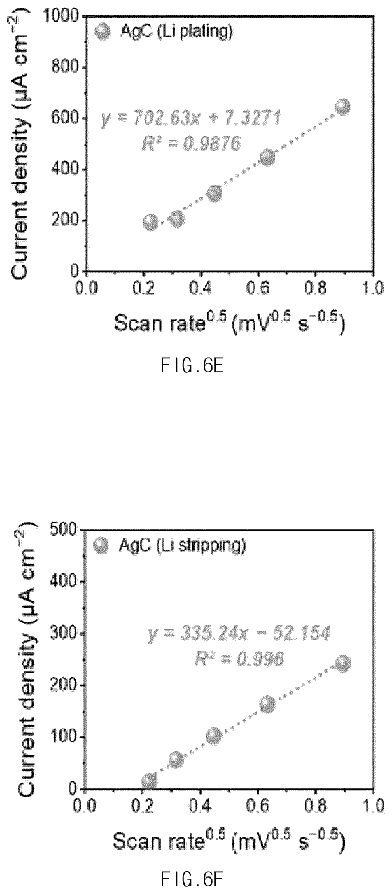

For the electrodes of the manufacturing example 1, and the electrodes of the Comparative Manufacturing Example 2, half cells were manufactured and evaluated to compare the lithium ion diffusion coefficients of the electrodes themselves. Then, the electrodes of the manufacturing example 1 of the present disclosure and the Comparative Manufacturing Example 2 were used as the half cells, Li₆PS₅Cl and a lithium metal were used as a solid electrolyte, and the lithium ion diffusion coefficient was measured by using cyclic voltammetry (CV) at 30° C. conditions, the measurement voltage was 0.5 V, and the measurement was conducted starting from an initial scan speed of 0.5 mV/s while increasing the scan speed by 2 times every 10 seconds as the step progressed. The lithium ion diffusion coefficient (DLi) was indirectly identified by measuring the current density depending on the scan speed by using the Randles-Sevcik equation (Equation 2), and the results are as in FIGS. 6A to 6F.

$${i}_{p} = 0.4463 {nFAC ( \frac{nFvD}{RT} )}^{\frac{1}{2}} \qquad [ Equation 2 ]$$

$$Or if the solution is at 25 ° C . \text{?}$$

$${i}_{p} = 2.69 \times {10}^{5} {n}^{3 / 2} AC \sqrt{Dv}$$

$$\text{?} \text{indicates text missing or illegible when filed}$$

wherein,
iₚ: peak current value (A)
n: number of electrons involved in the redox reaction
A: electrode area (cm²)
D: diffusion coefficient (cm²/s)
C: concentration (mol/cm³)
v: scanning rate (V/s)

As illustrated in FIGS. 6A to 6F, it may be identified that the current density depending on the scan speed in the electrode of the manufacturing example 1 was higher than that in the Comparative Manufacturing Example 2, and the lithium-ion diffusion coefficient of the electrode of the manufacturing example 1 was about 2.3 times higher during charging and about 2.4 times higher during discharging than the lithium-ion diffusion coefficient of the electrode of the Comparative Manufacturing Example 2. Through this, it was identified that in the case of the electrode of the manufacturing example 1, a sufficient lithium ion diffusion coefficient may be secured even under a room temperature (30° C.) conditions, and the battery may be stably driven without short circuiting during charging and discharging even at a room temperature.

### Fifth Experimental Example-Comparison of Lithium Ion Diffusion Coefficients (3)

For the anode-less all-solid-state battery of the Example 1 and the anode-less all-solid-state battery of the Comparative

Example 2, an electrochemical evaluation was conducted to compare the lithium ion diffusion coefficients of the anode-less all-solid-state batteries themselves. The difference between the lithium-ion diffusion coefficients was indirectly identified by a type of an overvoltage value called a voltage relaxation voltage, and generally, as the overvoltage value decreases, the lithium-ion diffusion coefficient increases, and thus, the lithium-ion diffusion coefficients were compared by using the calculated overvoltage values.

Voltage Relaxation=(voltage immediately after current application ends−voltage in steady state)

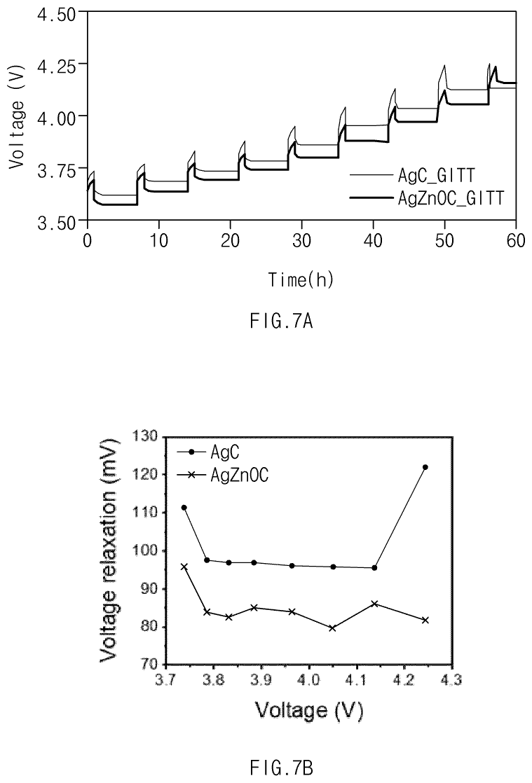

As illustrated in FIGS. 7A and 7B, it was indirectly identified that the anode-less all-solid-state battery of the Example 1 had a higher lithium ion diffusion coefficient than the anode-less all-solid-state battery of the Comparative Example 2 because a lower overvoltage was applied.

### Sixth Experimental Example-Volume Expansion Relaxation Effect

To identify the volume expansion relaxation effect during charging of the anode-less all-solid-state battery, nine random points were set on the anode-less all-solid-state battery of the Example 1 and the anode-less all-solid-state battery of the Comparative Example 2, and the average value and a deviation of the thickness difference between the initial and charged states were measured, and the change in the thickness per electric capacity was calculated to identify the volume expansion relaxation effect, and the experimental results are represented in Tables 2 to 5 below.

TABLE 2

| Evaluated capacity | | 1st | 2nd | 3rd | 4th | 5th | 6th |
|---|---|---|---|---|---|---|---|
| (3.28 mAh/cm²) | | point | point | point | point | point | point |
| Example 1 | Initial thickness | 545 | 544 | 544 | 543 | 545 | 542 |
| | (μm) | | | | | | |
| | Thickness after | 560 | 560 | 560 | 560 | 559 | 559 |
| | charging (μm) | | | | | | |
| | Increase (μm) | +15.0 | +16.0 | +16.0 | +17.0 | +14.0 | +17.0 |
| | Change in | 4.46 | 4.76 | 4.76 | 5.06 | 4.17 | 5.06 |
| | thickness per | | | | | | |
| | capacity (μm/mAh) | | | | | | |

TABLE 3

| Evaluated capacity | | 7th | 8th | 9th | Average | |
|---|---|---|---|---|---|---|
| (3.28 mAh/cm²) | | point | point | point | value | Deviation |
| Example 1 | Initial thickness | 543 | 543 | 542 | 543.4 | 1.130 |
| | (μm) | | | | | |
| | Thickness after | 560 | 561 | 560 | 559.9 | 0.601 |
| | charging (μm) | | | | | |
| | Increase (μm) | +17.0 | +18.0 | +18.0 | +16.4 | — |
| | Change in | 5.06 | 5.36 | 5.95 | 4.89 | — |
| | thickness per | | | | | |
| | capacity (μm/mAh) | | | | | |

TABLE 4

| Evaluated capacity | | 1st | 2nd | 3rd | 4th | 5th | 6th |
|---|---|---|---|---|---|---|---|
| (3.28 mAh/cm²) | | point | point | point | point | point | point |
| Comparative | Initial thickness | 544 | 546 | 542 | 545 | 545 | 546 |
| Example 2 | (μm) | | | | | | |
| | Thickness after | 567 | 564 | 558 | 562 | 560 | 559 |
| | charging (μm) | | | | | | |
| | Increase (μm) | +23.0 | +18.0 | +16.0 | +17.0 | +15.0 | +13.0 |
| | Change in | 7.10 | 5.49 | 4.88 | 5.18 | 4.57 | 3.96 |
| | thickness per | | | | | | |
| | capacity (μm/mAh) | | | | | | |

TABLE 5

| Evaluated capacity | | 7th | 8th | 9th | Average | |
|---|---|---|---|---|---|---|
| (3.28 mAh/cm²) | | point | point | point | value | Deviation |
| Comparative | Initial thickness | 546 | 544 | 540 | 544.1 | 1.965 |
| Example 2 | (μm) | | | | | |
| | Thickness after | 565 | 565 | 559 | 562.1 | 3.257 |
| | charging (μm) | | | | | |
| | Increase (μm) | +20.0 | +21.0 | +19.0 | +18.0 | — |
| | Change in | 6.10 | 6.40 | 5.79 | 5.49 | — |
| | thickness per | | | | | |
| | capacity (μm/mAh) | | | | | |

As represented in Tables 2 to 5 above, it was identified that the anode-less all-solid-state battery of the Example 1 had lower average values and deviations of thickness increase per electric capacity before and after charging than the anode-less all-solid-state battery of the Comparative Example 2, and the thickness increase per electric capacity of the anode-less all-solid-state battery of the Example 1 was reduced by about 10.82% [(5.49-4.89)/5.49*100] compared to the anode-less all-solid-state battery of the Comparative Example 2. This is because zinc (Zn) that is a lithium-compatible metal is dispersed within the carbon area of the anode-less all-solid-state battery, and as a lithium oxide (Li₂O) formation reaction is induced during charging, lithium ions are uniformly deposited in the pores of the carbon area and thus, which relatively alleviates the volume expansion effect is relatively alleviated.

### Seventh Experimental Example-Identification of Lithium Deposition Position in Electrode and Evaluation of Volume Expansion Relaxation Effect

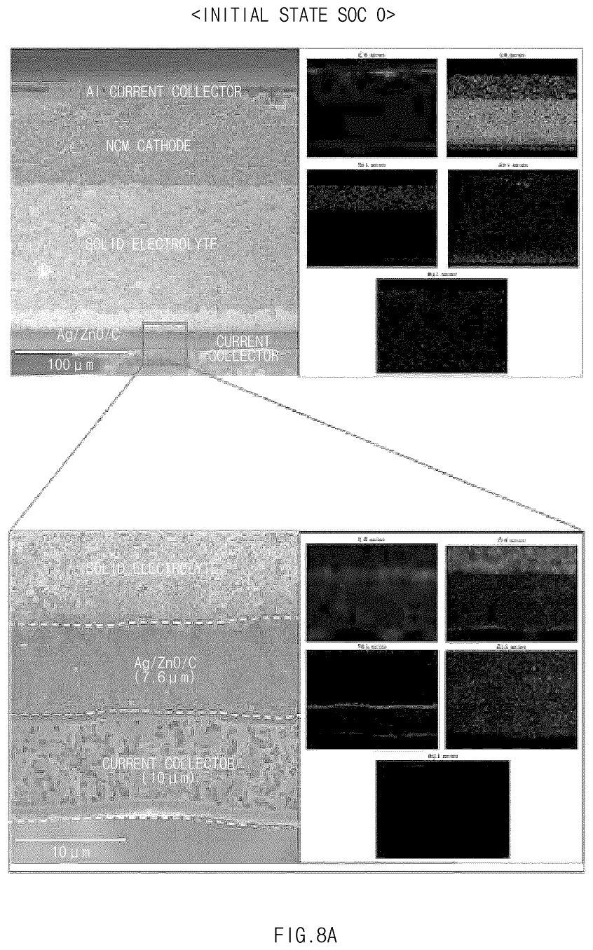

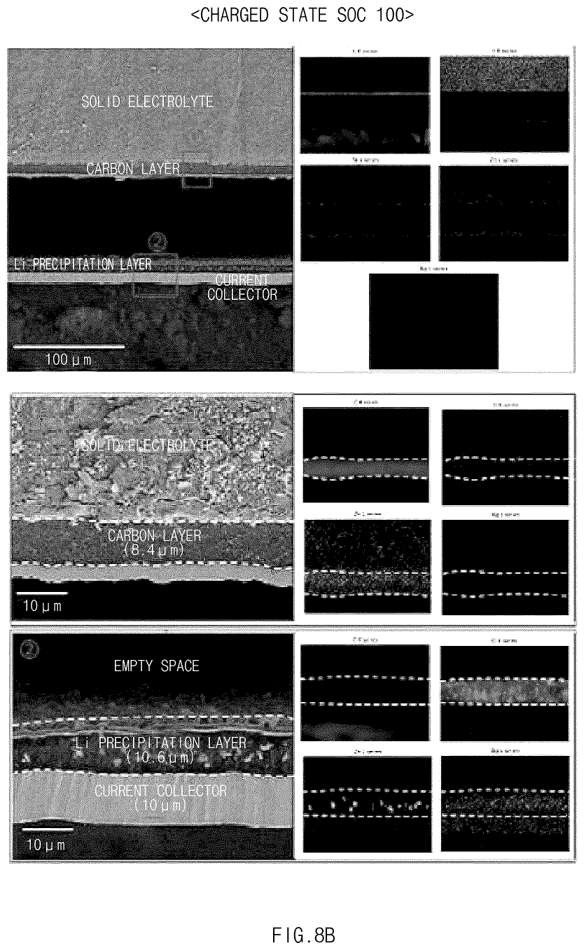

To identify the lithium deposition position in the electrode and to evaluate the volume expansion relaxation effect in the charged state of the anode-less all-solid-state battery of the Example 1, the cross-section of the anode-less all-solid-state battery in the initial state and the cross-section of the anode-less all-solid-state battery in the fully charged state (SOC 100) by applying a current of 3.3 mAh/cm² were analyzed through photographing of SEM (Hitachi) images, and the results are illustrated in FIG. 8A and FIG. 8B.

As illustrated in FIGS. 8A and 8B, it was identified that in the cross-section of the anode-less all-solid-state battery of the Example 1 in a fully charged state, a lithium precipitation layer was formed in an area under the carbon layer in the intermediate layer, and that lithium was uniformly deposited on opposite surfaces of the carbon layer and the Li precipitation layer. Furthermore, it was identified that the thickness of the electrode after charging (a sum of the thicknesses of the carbon layer and the Li precipitation layer) increased by approximately 11.4 μm compared to the initial state (approximately 7.6 μm) to approximately 19.0 μm, and the thickness increase per electrodeposition capacity was 3.45 μm/mAh (11.4 μm/3.3 mAh).

According to the present disclosure, the anode-less all-solid-state battery that may be stably driven without short-circuiting even at a room temperature during charge and discharge may be obtained.

In addition, an anode-less all-solid-state battery that has excellent durability characteristics while having a volume expansion alleviation effect by inducing uniform deposition of lithium ions at an interface of an intermediate layer may be obtained.

### Eighth Experimental Example-Evaluation of Rate Characteristics Depending on Particle Diameters of Metal and Metal Oxide

By using the anode-less all-solid-state batteries manufactured in the Examples 1 to 5, the initial discharge capacity was measured by performing a pre-cycle at 30° C., in which charging was performed to 4.25V in a CC/CV mode at a constant current of 0.2C, followed by discharging to 2V at 0.2C.

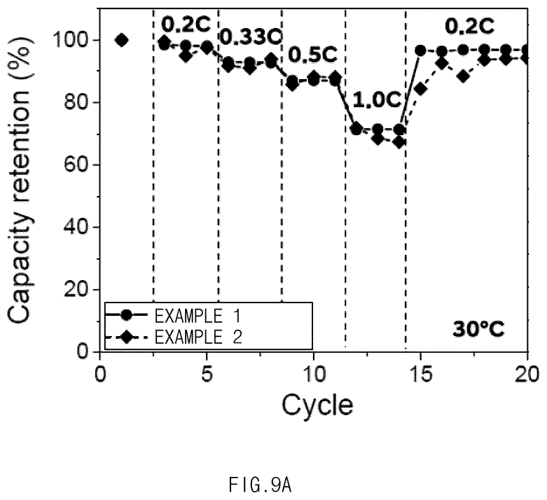

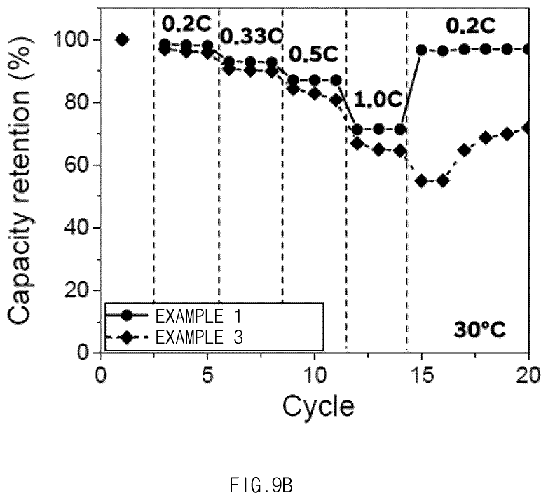

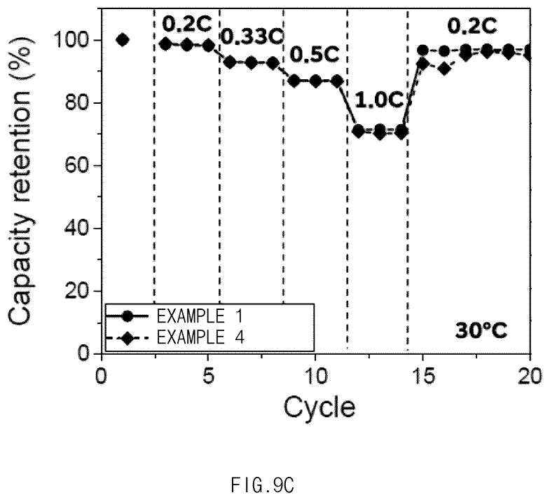

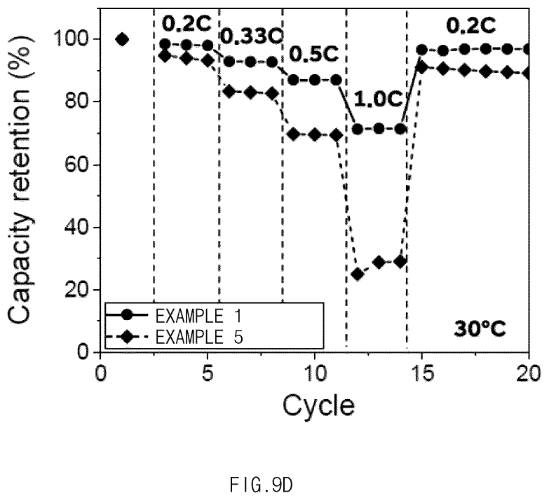

Subsequently, charge/discharge cycling was performed at 0.2C during the third to fifth cycles (first section), at 0.33C during the sixth to eighth cycles (second section), at 0.5° C. during the ninth to eleventh cycles (third section), at 1.0C during the twelfth to fourteenth cycles (fourth section), and again at 0.2C during the fifteenth to twentieth cycles (fifth section), and the ratio (%) (discharge capacity at specific cycle/initial discharge capacity of the Example 1)×100) of the discharge capacity at each specific cycle in each section of each embodiment to the initial discharge capacity of the Example 1 was calculated, and the results are illustrated in Table 6 and FIGS. 9A to 9D.

TABLE 6

| | | Example | | | |
|---|---|---|---|---|---|
| | Example | 2Example | Example | Example | Example |
| — | 1 | 2 | 3 | 4 | 5 |
| Pre-cycle | 100 | 100 | 100 | 100 | 100 |
| discharge | | | | | |
| capacity | | | | | |
| (0.2 C, %) | | | | | |
| Fourth | 98.3 | 97.4 | 96.3 | 98.5 | 94.0 |
| cycle | | | | | |
| discharge | | | | | |
| capacity | | | | | |
| (0.2 C, %) | | | | | |
| Seventh | 92.8 | 92.3 | 90.3 | 92.7 | 83.0 |
| cycle | | | | | |
| discharge | | | | | |
| capacity | | | | | |
| (0.33 C, %) | | | | | |
| Tenth | 87.0 | 87.4 | 82.6 | 86.8 | 69.6 |
| cycle | | | | | |
| discharge | | | | | |
| capacity | | | | | |
| (0.5 C, %) | | | | | |
| Thirteenth | 71.4 | 69.3 | 65.5 | 70.4 | 27.6 |
| cycle | | | | | |
| discharge | | | | | |
| capacity | | | | | |
| (1.0 C, %) | | | | | |
| Fifthteenth | 96.7 | 84.4 | 55.0 | 92.4 | 91.1 |
| cycle | | | | | |
| discharge | | | | | |
| capacity | | | | | |
| (0.2 C, %) | | | | | |

Referring to Table 6 and FIGS. 9A to 9D, it was identified that the anode-less all-solid-state battery according to the Example 1 exhibited more enhanced rate characteristics under a high current density (C-rate) condition of 1C compared to the anode-less all-solid-state batteries according to the Examples 2 and 4s and that a decrease in discharge capacity was suppressed when returned to a low current density (C-rate) condition of 0.2C.

This is interpreted as resulting from the fact that, when the particle diameter of silver (Ag) particles or zinc oxide (ZnO) particles electrodeposited in the form of dual seeds within matrix pores satisfies an optimal range, aggregation into secondary particles due to van der Waals forces is suppressed, thereby further enhancing the electrochemical reactivity of lithium ions, and the specific surface area of the silver (Ag) particles or zinc oxide (ZnO) particles is optimized to broaden the electron transport pathways and reduce electrode resistance.

Specifically, compared to the Example 2, Example 2 and the Example 4, in which the particle diameters of the silver (Ag) particles or zinc oxide (ZnO) particles are relatively small, it was identified that, in the Example 1, aggregation between primary particles due to van der Waals forces was mitigated during the slurry dispersion process, thereby leading to the formation of secondary particles having a relatively small particle diameter, and that the participation of the formed secondary particles in electrochemical reactions with lithium was enhanced.

In addition, compared to the Example 3 and the Example 5, in which the particle diameters of the silver (Ag) particles or zinc oxide (ZnO) particles are relatively large, it was identified that, in the Example 1, the entire dual-seed particles could readily participate in electrochemical reactions with lithium, resulting in improved discharge capacity and, in particular, a smaller decrease in capacity at high current density (C-rate).

What is claimed is:

1. An electrode comprising:
a current collector; and
an intermediate layer disposed on the current collector,
wherein the intermediate layer comprises:
a matrix comprising a carbon material;
a lithium-alloyable metallic element, a lithium-alloyable metalloid element, or a combination thereof, which is dispersed in the matrix; and
a lithium-alloyable metal oxide, a lithium-alloyable metal fluoride, a lithium-alloyable metalloid oxide, a lithium-alloyable metalloid fluoride, or a combination thereof, which is dispersed in the matrix.

2. The electrode of claim 1, wherein the carbon material is at least one of carbon black, acetylene black, Ketjen black, panel black, furnace black, lamp black, thermal black, natural graphite, artificial graphite, graphene, fullerene (C₆₀), single-walled carbon nanotubes, multi-walled carbon nanotubes, vapor-grown carbon fibers, carbon felt, and/or carbon paper.

3. The electrode of claim 1, wherein the carbon material comprises amorphous carbon.

4. The electrode of claim 1, wherein the lithium-alloyable metallic element, the lithium-alloyable metalloid element, or the combination thereof is at least one of Ag, Mg, Zn, Au, Sn, Ge, In, Si, Ga, Al, Sb, Pb, Bi, and/or Cd.

5. The electrode of claim 1, wherein the lithium-alloyable metal oxide, the lithium-alloyable metal fluoride, the lithium-alloyable metalloid oxide, the lithium-alloyable metalloid fluoride or the combination thereof is an oxide or a fluoride in which at least one metallic element or metalloid element comprises Ag, Mg, Zn, Au, Sn, Ge, In, Si, Ga, Al, Sb, Pb, Bi, and/or Cd, and is stoichiometrically balanced.

6. The electrode of claim 1, wherein the carbon material has an average particle diameter being larger than an average particle diameter of particles comprised in the lithium-alloyable metallic element, the lithium-alloyable metalloid element, or the combination thereof, and particles comprised in the lithium-alloyable metal oxide, the lithium-alloyable metal fluoride, the lithium-alloyable metalloid oxide, the lithium-alloyable metalloid fluoride, or the combination thereof.

7. The electrode of claim 1, wherein the carbon material comprises carbon material having an average particle diameter of 1 nm or more and 100 μm or less.

8. The electrode of claim 1, wherein an average particle diameter of particles comprised in the lithium-alloyable metallic element, the lithium-alloyable metalloid element, or the combination thereof is 1 nm or more and 100 μm or less.

9. The electrode of claim 1, wherein an average particle diameter of particles comprised in the lithium-alloyable metal oxide, the lithium-alloyable fluoride, the lithium-alloyable metalloid oxide, the lithium-alloyable fluoride, or the combination thereof is 1 nm or more and 100 μm or less.

10. The electrode of claim 1, wherein the intermediate layer comprises the metallic element, the metalloid element or the combination thereof, and the metal oxide, the metal fluoride, the metalloid oxide, the metalloid fluoride or the combination thereof at a content of more than 0 wt % and 50 wt % or less.

11. The electrode of claim 1, wherein the intermediate layer comprises the metallic element, the metalloid element or the combination thereof, and the metal oxide, the metal fluoride, the metalloid oxide, the metalloid fluoride or the combination thereof at a weight ratio of 1:0.1 to 9.

12. The electrode of claim 1, wherein the intermediate layer comprises:
a matrix comprising amorphous carbon;
Ag dispersed in the matrix; and
ZnO dispersed in the matrix.

13. The electrode of claim 12, wherein the intermediate layer further comprises:
Li₂O dispersed in the matrix; and
LiₓZn dispersed in the matrix, wherein 0<x<1.

14. The electrode of claim 1, wherein a thickness of the electrode is 1 μm or more and 100 μm or less.

15. An electrode comprising:
a current collector; and
an intermediate layer disposed on the current collector,
wherein the intermediate layer comprises:
a matrix comprising a carbon material;
a lithium-alloyable metallic element, lithium-alloyable metalloid element, or a combination thereof, which is dispersed in the matrix; and
Li₂O dispersed in the matrix.

16. A method for manufacturing an electrode, the method comprising:
manufacturing slurry by mixing a carbon material, an inorganic element, an inorganic compound, a binder, and a solvent;
applying the slurry to at least one surface of a current collector; and
drying the slurry,
wherein the inorganic element comprises a lithium-alloyable metallic element, a lithium-alloyable metalloid element, or a combination thereof, and
wherein the inorganic compound comprises a lithium-alloyable metal oxide, a lithium-alloyable metal fluoride, a lithium-alloyable metalloid oxide, a lithium-alloyable metalloid fluoride, or a combination thereof.

17. An anode-less all-solid-state battery comprising:
a cathode, an anode, and a solid electrolyte layer disposed between the cathode and the anode,
wherein the cathode comprises a cathode active material layer comprising a cathode active material,
wherein the anode is the electrode of claim 1, and
wherein the solid electrolyte layer is disposed between the cathode active material layer and the intermediate layer.

18. The anode-less all-solid-state battery of claim 17, wherein the cathode active material comprises a lithium transition metal complex oxide.

19. The anode-less all-solid-state battery of claim 17, wherein the solid electrolyte layer comprises a sulfide solid electrolyte.

20. The anode-less all-solid-state battery of claim 19, wherein the sulfide solid electrolyte comprises an argyrodite-type sulfide solid electrolyte.

21. The anode-less all-solid-state battery of claim 17, wherein when the anode-less all-solid-state battery is charged 100 times or more, at least one of lithium (Li) and silver (Ag) comprises a precipitate between the intermediate layer and the current collector.

22. The anode-less all-solid-state battery of claim 17, wherein when the anode-less all-solid-state battery is charged 100 times or more, the anode comprises a thickness of 5 μm to 100 μm.
